(19) United States
(12) Patent Application Publication
(10) Pub. No.: US 2018/0247556 A1
(43) Pub. Date: Aug. 30, 2018

(54) SYSTEM OF ELECTRONIC DEVICES FOR ENHANCED LEARNING PATHS AND SIMULTANEOUS CONSTANT EVALUATION OF USERS LEARNING LEVEL

(71) Applicant: Arcadia Consulting S.R.L., Cittadella (PD) (IT)

(72) Inventor: Stangherlin Orazio, Cittadella (PD) (IT)

(21) Appl. No.: 15/905,160

(22) Filed: Feb. 26, 2018

(30) Foreign Application Priority Data
Feb. 27, 2017 (CH) 0227/17

(51) Int. Cl. G09B 9/00; G09B 7/02; A63F 13/85; A63F 13/211; A63F 13/213

(52) U.S. Cl. CPC G09B 9/00; G09B 7/02; A63F 13/213; A63F 13/211; A63F 13/85

(57) ABSTRACT

A system of electronic devices for enhanced learning paths and simultaneous constant evaluation of users' learning level on the basis of predetermined criteria comprising a set of electronic devices such as a virtual reality devices (1) or an enhanced reality device (2) and simulation interfaces (3), the latter equipped aboard at least a first electronic equipment (4) suitable for transmitting signals to the first electronic device (1), to the second electronic device (2), or to a second centralized receive electronic equipment (5).

### OBJECT OF THE INVENTION

An object of the present invention is to provide a system of electronic devices for enhanced learning paths, i.e. paths suitable for speeding up and making it easier learning by users. Another object of the present invention is to make it possible, by way of said system, a simultaneous and constant evaluation of the learning level of users on the basis of predetermined criteria

### PRESENT STATUS OF THE ART

People training emerges as an unavoidable process at the personal level as well as a strategic social process, not only for producing the knowledges necessary for a good operation of social institutions, including enterprises and administrations, but also for a production of citizenship and social capital which involves every citizen for the span of his/her life.

In this framework, digital technologies massively invade the modern life and revolutionize schemes and approaches, challenge stereotypes and traditionally training rules, and open enormous spaces for innovation.

However, often are the technologies used to support classic methodologies, without any view to the innovation capabilities that might be brought by the latter to the teaching processes.

The methodologies and instruments known and used in the training sector, which is by now a true industrial sector, are apparently lacking of an orientation, a strategy, a picture capable not only of tackling the individual knowledge problems, but also of integrating the three still separate fields of formal, non-formal, and informal education in a unitary training environment.

Instruments have been adopted in the training sector that follow classic transmissive models, imitate frontal teaching classroom logics, wherein a user is nothing but a passive receptor of information. This takes place both in classroom, as well as in online didactics, in E-learning, and in blended-like training proposals, featuring classroom moments alternating to on line moments. The focus is still on a teacher who teaches, rather than on a user who learns. The instruments adopted are thus substantially limited to blackboards, even if they are now electronic or a set of slides previously prepared by a teacher.

Said training methodologies and instruments are applied, notwithstanding the known training theories. Think of the Social Activism by Dewey dating back to late '800 and of the Andragogy by Knowles, which assert the importance of a direct involvement and co-designed experience in learning processes.

By virtue of these theories and of the taking of awareness of the limits of an exclusively transmissive teaching, more active methodologies have been developed aiming at bringing users “out of the classroom”, such as the outdoor training ones.

A methodology more recently adopted in the training sector extremizes the concept of customization while leaving an absolute freedom and autonomy to users with respect to the choice of methodologies, instruments, and learning arguments. This methodology entails a risk of a failed integration of the organizational context with the nature of the learnings themselves and of the difficulties in evaluating the processes and the skills and knowledges acquired by users.

In such framework of training methodologies, other teaching equipment and instruments have also been applied, in addition to the mentioned blackboard. In such environment, think of computer and other IT instruments.

However, the known use of said instruments in the training sector did not provide advantageous results, but got the same effect and result as a classic blackboard.

### DISCLOSURE OF THE INVENTION

People has less and less time to dedicate to the information to be acquired and does it in the most varied moments, training is not made any longer in long lasting classroom sessions, but is rather a sequence, a more distributed and continuous process of small learning units.

In order to solve these drawbacks, traditional training being less and less effective, a methodology has been identified for answering the present attentional deficit, which can be defined as a difficult for a subject to remain hooked and connected to the information he/she is acquiring for a long period of time. Such deficit presently originates from that phenomenon which is called non-linear learning: there is no longer a traditional learning wherein a sequence of information units are received altogether, but rather information is acquired by benefiting from small learning units or by using other methods. Such methodology aims at designing enhanced learning paths, i.e. paths suitable for speeding up and making it easier learning by users, thereby reducing the learning time and increasing the quantity of knowledges acquired by users as compared to traditional training, the dedicated time being equal.

A variety of electronic means is to be adopted to apply such enhanced learning methodology. The scope of the present invention is a system of electronic devices used to implement enhanced learning paths in a surprisingly advantageous manner, by adopting training instruments different from those adopted by traditional training and solving the problems of traditional training.

Innovative learning paths require instruments for evaluating the learning results. According to the present invention, the system is organized for a simultaneous and constant evaluation of the users' learning level on the basis of predetermined criteria.

In order to better appreciate the system of electronic devices according to the present invention, it is worth illustrating the framework in which said system operates, in particular the individual component parts which the enhanced learning methodology is based on.

Training Molecules: they are short interventions of dealt with contents, limited in terms of numerousness but stimulating, amusing, and pleasant, which make it possible to update/provide knowledges in a particular area of interest. They are easily assimilable and feature a strong practical orientation.

Multimedia Learning: it is a contents transfer and acquisition mode which organizes information in several presentation formats, i.e. by using both materials in a verbal format and materials in a graphical format. It is a knowledge transfer mode that is particularly effective in that it speeds up the concept acquisition process, while contributing to the construction of knowledges rather than to a merely mnemonic transfer of information. According to the present invention, the multimedia learning contents are in a software format.

Experimentations, which start from the learning by doing concept, which asserts a learning generated and facilitated by the introduction of a practical action, but is not limited thereto. It needs a reflection on the action itself and a deep user's understanding and interiorization in order for it to be implemented. According to this methodology, the learning place is a virtual laboratory by way of the system according to the present invention. In such virtual laboratory, a user experiments actions and the outcomes thereof. Learning takes place through discovery, a user is not a passive receptor of stimuli, but he/she becomes an active protagonist of the process. Training is used to organize the experience and to make it significant so as to enhance his/her capability of managing subsequent experiences.

Gamification: It consists of applying five game mechanics, such as scores, levels, challenges, virtual goods, and leaderboards to processes, such as company processes and training processes, in specific industrial or scientific sectors. These mechanics determine the so-called game dynamics along with their respective psychologic effects: the need for recognizing their own efforts, identified by scores; social recognition and improvement of his/her own status, identified by levels; achievement of a result and overcoming of a sudden obstacle, identified by challenges; expression of his/her own individuality and diversity, as well as exchange, identified by virtual goods, contest-competition, identified by leaderboards. These dynamics determine an increased degree of engagement. That is to say, a user tends to persist more on gamified learning paths, to often come back to the leaderboard to see where the other “players” are and to decide to improve his/her own position. As a consequence, a user learns more and improves the degree of knowledge retention and learning motivation. Also, by now known concepts such as storytelling and self-learning are bound to gamification, which already demonstrated their effectiveness in training users, in particular adult users. As it will even more evidently come out, an effective application of the described methodology needs a number of instruments, preferably electronic instruments. In order to achieve an effective result in applying this training methodology, the electronic means shall be identified, related to each other, and implemented in a novel manner, without following the wealth of experiences gained until now.

Assignment. It is a training mode based on assigning to participants activities to be performed autonomously or in teams out of the classroom moment. It can be assisted by a use of simulators and interaction instruments in teamwork from a remote location. A flipped classroom trend is related to this mode, wherein the traditional training concept, whereby a teacher presents in the classroom the contents which are subsequently autonomously reworked by users in a moment following the lesson, is reversed. In the case of a flipped classroom, the materials, which are also made interactive and stimulating thanks to the use of rich media, are supplied before the lesson, which becomes a moment wherein his/her own learnings are consolidated thanks to contest and practice.

A set of electronic devices shall be used to implement the methodologies illustrated in the previous paragraphs for an enhanced learning path and simultaneous constant evaluation of the users' learning level. Such devices used to implement said methodologies include:
behavior simulators: software applications, which reproduce the behavior of a process or a real system, by way of a simplified model of its specific characteristics and functions. Behavior simulators are structured to reproduce situations similar to the real ones so as to apply whatever learned by a user from a theoretical point of view in order to verify the knowledges learned by the user in a controlled and safe environment, for instance in order to follow given procedures and/or behaviors.
   Simulators are also used for evaluating the user's learning level.
   Gamification, preferably software-based, electronic devices.
Task, preferably software-based, electronic devices, used for task sharing and assignment, brainstorming, and idea categorization.
Rewarding/badging software. As is known, the term rewarding means gratifying and giving a prize to users for the actions performed, whereas a badge is a validated indicator of a complete activity or of an acquired skill. The software is organized so as to reward a user by associating him/her with a prize or with an achieved result.
Virtual reality devices organized for reproducing an environment, be it real or imaginary, wherein a user can interact with all of the five senses.
Test/survey softwares organized for creating, managing, modifying, and combining sets of questions of different types for a constant evaluation of the learning level of a user on the basis of predetermined criteria. The test/survey software is preferably associated with games, insofar they are proposed in this format, in order to enhance user involvement.
Electronic devices for obtaining an enhanced reality. This category includes those softwares which make it possible to create and manage enhanced reality applications. Said enhanced reality devices are organized for enriching a text with contents by displaying a tridimensional image up to applications that, by way of smartphones or wearables, make it possible to see the surrounding reality, and with additional information which enriches the latter.

All of the above listed instruments are connected to each other to build up a system of electronic devices for enhanced learning paths and a simultaneous constant evaluation of the learning level of a user on the basis of predetermined criteria.

Alternatively, the system comprises at least a first virtual reality electronic device or a second enhanced reality electronic device. Said devices are used directly by a user, who uses them to receive and interact with images, words, and sounds transmitted by a first electronic equipment, such as a computer, a tablet, or a smartphone, aboard which there is installed a third simulation interface electronic device. Such third device is preferably a software. It contains the mentioned training molecules in the form of e-textbook and/or multimedia learning information and/or virtual laboratories and/or gamification software, behavior simulator, and interactive video.

The first equipment is also equipped for transmitting signals to a second centralized receive electronic equipment. The signals transmitted by the first equipment to the second centralized equipment are signals that represent the user interaction with the third simulation interface electronic device. The signals received by the second electronic equipment are thus processed for a constant and immediate evaluation of the user learning level. Such evaluation makes also it possible to evaluate the effectiveness of the contents present in the third simulation interface electronic device concerning user learning.

Alternatively, the first device is a virtual reality display, a cardboard, at least one Leap Motion, at least one Thalmic Myo. It has been experimentally observed that these devices, basically used for videogames, surprisingly demonstrated being very effective in training activities if integrated in the system according to the present invention.

The second enhanced reality device is connected to at least a fourth electronic device, a software, organized for supplying the second electronic device (2) with signals concerning graphical, non-enhanced-reality-related elements.

In one embodiment, an interactive platform is provided having a fifth learning game simulation interface electronic device, a behavior simulator, an interactive video, or an e-textbook aboard. In this interactive format, the third simulation interface electronic device is totally or partially replaced by the mentioned fifth electronic device, depending on the operator's choices.

### DESCRIPTION OF THE FIGURE

FIG. 1 shows a system of electronic devices for enhanced learning paths and simultaneous constant evaluation of a user's learning level on the basis of predetermined criteria according to the present invention.

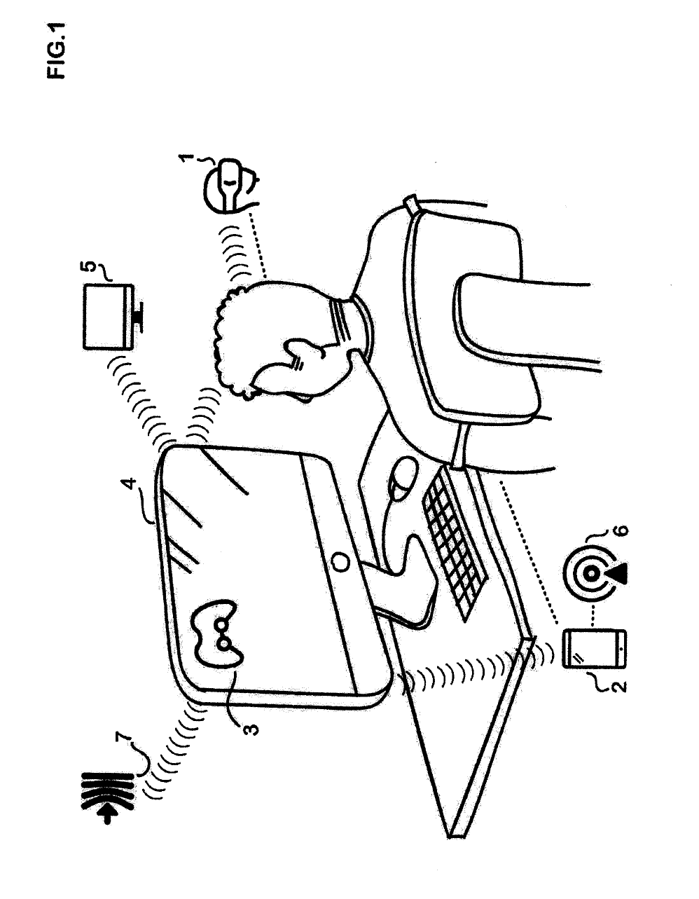

The system alternatively provides at least a first virtual reality electronic device (1) or a second enhanced reality electronic device (2). Said devices, used by a user, are connected to a third simulation interface electronic device (3) aboard at least a first electronic equipment (4). Said first equipment (4) is suitable for transmitting signals to the first electronic device (1) or to the second electronic device (2) and to a second centralized receive electronic equipment (5). The first device (1) is alternatively a virtual reality display, a cardboard, at least one Leap Motion, at least one Thalmic Myo, none of them shown in the figure. The second device (2) is an enhanced reality device connected to at least a fourth electronic device (6) suitable for supplying signals to the second enhanced reality electronic device (2). In one embodiment, graphically shown in FIG. 1, there is provided an adaptive platform (7) alternatively equipped with a fifth learning game electronic device (8), a behavior simulator (9), an interactive video (10), or an e-textbook (11). The devices 8 thru 11 are not shown in the figure.

1. A system of electronic devices for enhanced learning paths and simultaneous constant evaluation of users' learning level on the basis of predetermined criteria, characterized in that it comprises:
(a) at least a first virtual reality electronic device (1) or alternatively an enhanced reality electronic device (2) connected to
(b) a third simulation interface electronic device (3) aboard at least a first electronic equipment (4), the first equipment (4) being suitable for transmitting signals to the first electronic device (1) or to the second electronic device (2) and to a second centralized receive electronic equipment (5).

2. The system of electronic equipment according to claim 1 characterized in that the first device (1) is alternatively:
a) a virtual reality display or a card board connected to an electronic equipment (computer/smartphone);
b) at least one Leap Motion;
c) at least one Thalmic Myo.

3. The system of electronic equipment according to claim 1 characterized in that the second device (2) is an enhanced reality device connected to at least a fourth electronic device (6) suitable for supplying signals to the second enhanced reality electronic device (2).

4. The system of electronic equipment according to claim 2 characterized in that it comprises an adaptive platform (7).

5. The system of electronic equipment according to claim 4 characterized in that it comprises an adaptive platform (7) alternatively equipped with a fifth learning game electronic device (8), a behavior simulator (9), an interactive video (10), or an e-textbook (11).
